(19) United States
(12) Patent Application Publication
(10) Pub. No.: US 2008/0162448 A1
(43) Pub. Date: Jul. 3, 2008

(54) METHOD FOR TRACKING SYNTACTIC PROPERTIES OF A URL

(75) Inventor: Piyoosh Jalan, San Jose, CA (US)

Correspondence Address: CANTOR COLBURN, LLP - IBM ARC DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/617,297

(22) Filed: Dec. 28, 2006

(51) Int. Cl. G06F 17/30; G06F 21/20

(52) U.S. Cl. 707/5; 726/1; 707/E17.108

(57) ABSTRACT

A method of classifying URLs by analyzing each URL discovered by a crawler and matching against a set of words corresponding to each class such as pornography, archive, obituary, business news, archive, politics, terrorism, etc. A count of the prefix of the URL to the class is updated and an action is performed with respect to electronic documents on the computer system based on the count. The action performed could be blocking the computer system from the crawling, or adjusting the frequency with which the computer system should be crawled.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to a method of classifying uniform resource locators (URL) by analyzing each URL discovered by the crawler and matching against a set of words corresponding to each class such as pornography, archive, obituary, business news, archive, politics, terrorism, etc. and particularly to performing an action which could include blocking the computer system from the crawling, or adjusting the frequency with which the computer system should be crawled.

2. Description of Background

A web crawler is a software program that fetches web pages from the Internet. The crawler is typically seeded with a few well known sites which it crawls and then parses the outlinks discovered from those pages and follows these newly discovered outlinks. This process is repeated to crawl the entire web.

The web or Internet is too large to be refreshed in a few weeks time. The web consists of different classes of URLs. Some sites primarily host pornographic pages, some media pages, some educational material etc. Different parts of a site sometimes fall into different classes of URLs such as archives, obituaries, world news, current news, etc. By analyzing the syntactic properties of a URL it can be classified into different classes such as pornography, archive, news, terrorism etc. This is achieved by counting the number of distinct prefixes that falls into a particular class.

One significant use of tracking syntactic properties of a URL is to track and block pornography sites. By counting the number of distinct pornography prefixes that exists in a site it can be classified as a pornography site. A modified crawl policy will completely block pornography sites from getting crawled thus utilizing the crawler bandwidth more efficiently by directing the crawler to crawl more important sites. Other significant application of this invention is to appropriately allocate crawling resources based on the class of a URL, such that archive pages are refreshed less often than a news page.

Currently there are some solutions employed to avoid crawling pornography pages. A string search is performed on a URL before being crawled with a list of pre-identified pornography words and if there is a match the URL is classified as pornography and is discarded. The drawback of this approach is that it does not help identify a site, which primarily hosts pornographic pages. By maintaining a count of distinct pornography prefixes from the URLs discovered for a site it can be classified as a pornography site and be completely blocked from getting crawled. The old approach wastes a lot computing resource by performing a string search on every URL before crawling.

There is a long felt need for a method of tracking syntactic properties of a URL that in part gives rise to the present invention.

### SUMMARY OF THE INVENTION

The shortcomings of the prior art are overcome and additional advantages are provided through the provision of a method for tracking syntactic properties of a URL, the method comprising: using a web crawler to discover a plurality of URLs; analyzing each of the plurality of URLs to identify one of a plurality of classes to which each of the plurality of URLs belong; determining for each of the plurality of classes a count of distinct prefixes; and performing an action based on the value of the count of distinct prefixes.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution which is a method of classifying URLs by analyzing each URL discovered by the crawler and matching against a set of words and then performing an action such as blocking the computer system from the crawling, or adjusting the frequency with which the computer system should be crawled.

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a method for tracking syntactic properties of a URL.

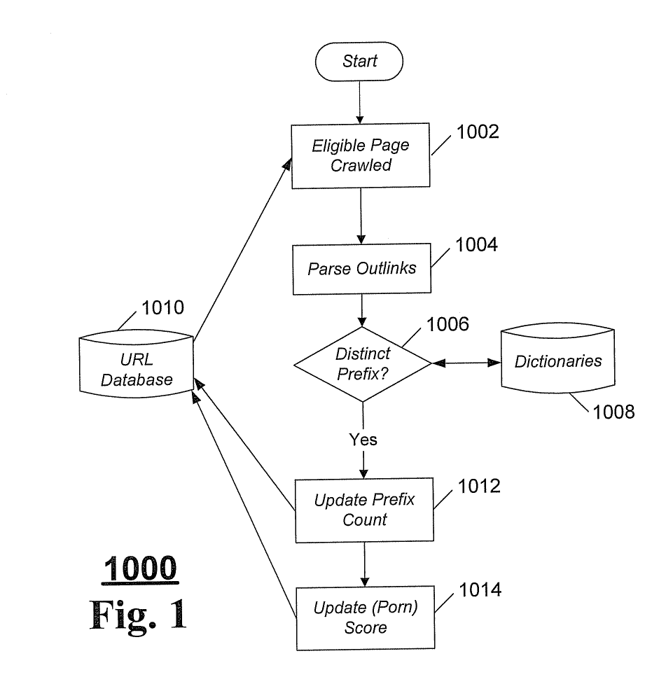

The detailed description explains the preferred embodiments of the invention, together with advantages and features, by way of example with reference to the drawings.

### DETAILED DESCRIPTION OF THE INVENTION

Turning now to the drawings in greater detail, every URL discovered by the web crawler is analyzed to identify the class to which it belongs and update the distinct prefix count corresponding to that class and site. So each discovered URL is matched against a list of pre-identified words corresponding to a class such as pornography, archive, obituary, sports news, business news, politics, terrorism etc. For each class a count of distinct prefixes is maintained using constant space (data structure and algorithm described below). Based on the number of distinct prefixes for a class different actions can be taken.

Such action can include for a pornography site based on the number of distinct pornography prefixes and the total count of URLs it could be classified as a pornography site and hence blocked entirely from getting crawled; different crawling policy could be applied to different classes of URLs for proper allocation of crawling resource. For example, archive pages could be set to be refreshed every six months, pornography pages could be blocked and current news pages could be attempted to be crawled as soon as possible; and site level statistics generation based on distinct prefix count for various classes of URLs.

For each class of URL such as archive, pornography, terrorist activities, sports news, etc. The method maintains a count of the number of distinct prefixes using constant space. For each class we maintain a separate bit vector to track the count of distinct prefixes. We first establish a range of values that counts should fall into. To explain this algorithm we make the following assumptions: 1) 64K unique prefixes to be the maximum count of interest; 2) four bytes of bit vector (32 bits) are used to store the count of identifiers; and 3) 32 bits are broken into 16 groups of two bits each.

The first group of two bits will be used for sites that have very few matching prefixes; the process sets those bits whenever one is found. The next group will be used for sites that have roughly 2-4 prefixes. A bit is set on about one half of the matching prefixes. So each bit will count for two bad prefixes. The third group will be used for sites with 4-8 matching prefixes. A bit is set on about ¼th of the matching prefixes, so each bit will count for four prefixes. Generally the i^{th} group will be set to ‘1’ on ‘1’ out of 2̂i matching prefixes, so each bit will count as 2̂i prefixes. Using this algorithm, the process counts the number of unique prefixes that exists in a site for each class.

An exemplary embodiment of the present invention can include, based on the number of distinct pornography prefixes identified and the total number of URLs discovered for a site, a score assigned to that site. Sites with a pornography score more than a threshold could be identified as a pornography site. Pornography sites are entirely blocked from being crawled thus resulting in effective utilization of crawler bandwidth by directing the crawler to crawl more important sites.

In an exemplary embodiment, for example and not limitation, the formula to calculate a pornography score can be expressed as:

Pornography score=(α*no of distinct bad prefixes/total no of URLs in site+β*total no of bad URLs/total no of URLs in site)*100

For e.g. α==0.7 & β==0.3

The above formula will result in a score between 0-100. The score as evaluated above has a myriad of uses. A crawler while selecting sites for crawling can do a sort on score. Certain sites with very high pornography score can be classified accordingly and be blocked from getting crawled, or have the crawl frequency adjusted.

For different classes of URLs such as news, media, archives, career related, job site, and terrorism related sites, etc. a separate dictionary is maintained. While doing URL preprocessing if a distinct prefix is found corresponding to one of the defined classes, the prefix count and the corresponding score is updated. To cite an example suppose for instance if classifying media sites, words such as business, law, sports, world, local, and current may be used as part of the media dictionary.

In this regard, prefixes like www.abcnews.com/*business*, www.abcnews.com/*law*, www.abcnews.com/*sports*, www.abcnews.com/*world*, www.abcnews.com/*local*, and www.abcnews.com/*current* will count towards the distinct prefixes count and help classify a site as primarily a media site and the pages belonging to that site could be appropriately ranked depending on the crawl policy defined for a media site.

In an exemplary embodiment, a formula to compute the score for a site will be:

Score=(α*no of distinct matching prefixes/total no of URLs in site+β*total no of matching URLs/total no of URLs in site)*100

e.g. α˜=0.7 & β˜=0.3

So for the above case of media it will produce a media score in between 0-100 and crawling resources could be accordingly allocated to this site.

In an exemplary embodiment, crawl policy could be modified to appropriately allocate crawling resources based on different classes of URL. For example a URL with matching pornography prefix could be forbidden from being crawled, URLs with matching archive prefix could be set to be re-crawled every six months and so on. This will result in more efficient utilization of the crawler bandwidth.

Statistics information could be generated based on the prefix counts for the various classes of URLs for a site. This will help classify a site as media, pornography, educational, etc. This will also help identify which sites have what percentage of news related to business or terrorist activities. Based on this the crawl policy for a site or its prefixes could be dynamically altered to better meet some business requirements. The method begins in block 1002.

In block 1002 eligible pages are crawled. Processing then moves to block 1004.

In block 1004 outlinks from the crawled pages are parsed. Processing then moves to decision block 1006.

In decision block 1006 a determination is made by querying dictionary 1008 as to whether or not the prefix is distinct. If the resultant is in the affirmative that is the prefix is distinct then the prefix count is retrieved and processing moves to block 1012. If the resultant is in the negative that is the prefix is not distinct then the prefix is added to the dictionary 1008 and processing continues at block 1012.

In block 1012 the prefix count is updated. If the site is a pornography site then the update pornography score in block 1014 occurs, the URL database is updated and processing returns to block 1002. If the site is not a pornography site then URL database is updated and processing moves back to block 1002.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for tracking syntactic properties of a URL, said method comprising:
using a web crawler to discover a plurality of URLs;
analyzing each of said plurality of URLs to identify one of a plurality of classes to which each of said plurality of URLs belong;
determining for each of said plurality of classes a count of distinct prefixes; and
performing an action based on the value of said count of distinct prefixes.

2. The method in accordance with claim 1, wherein analyzing includes matching each of said plurality of URLs to a list of pre-identified words corresponding to one of said plurality of classes.

3. The method in accordance with claim 2, further comprising:
adjusting a frequency at which said web crawler crawls certain of said plurality of URLs.

4. The method in accordance with claim 3, wherein adjusting further comprising:
setting said frequency based on said plurality of classes.

5. The method in accordance with claim 4, wherein a score for each of said plurality of URLs is determined by formula as:
score=(α*no of distinct bad prefixes/total no of URLs in site+β*total no of bad URLs/total no of URLs in site)*100.

6. The method in accordance with claim 5, performing said action further comprising:
blocking said web crawler from crawling a certain URL when determined, based in part on said count of distinct prefixes and said plurality of URLs, that said certain URL is a pornography website.

7. The method in accordance with claim 5, wherein said actions includes blocking said web crawler.

8. The method in accordance with claim 5, wherein said actions includes implementing an alternative said web crawler policy.

9. The method in accordance with claim 5, wherein said method assumes 64K unique prefixes to be the maximum count of interest.

10. The method in accordance with claim 9, wherein said method assumes use of four bytes of bit vector (32 bits) to store said count of distinct prefixes.

11. The method in accordance with claim 10, wherein said method assumes breaking said count of distinct prefixes 32 bits into 16 groups of two bits.

12. The method in accordance with claim 11, wherein said frequency is greater than six months.

13. The method in accordance with claim 12, wherein said list of pre-identified words includes pornography, archive, obituary, sports news, business news, politics, and terrorism.
